(19) United States
(12) Patent Application Publication
(10) Pub. No.: US 2013/0298549 A1
(43) Pub. Date: Nov. 14, 2013

(54) Actuator and Method

(71) Applicant: Samuel Michael Manriquez, JR., Round Rock, TX (US)

(72) Inventor: Samuel Michael Manriquez, JR., Round Rock, TX (US)

(21) Appl. No.: 13/854,976

(22) Filed: Apr. 2, 2013

Related U.S. Application Data
(60) Provisional application No. 61/686,378, filed on Apr. 4, 2012.

(51) Int. Cl. F03G 7/06

(52) U.S. Cl. CPC F03G 7/06
USPC 60/528; 29/890.03

(57) ABSTRACT

An actuator providing linear displacement, includes a plurality of planar-beam support structures disposed along a longitudinal axis; wherein each said plurality of planar-beam support structures are configured with more than one multidirectional, conductive, coplanar-beams disposed therein; such that said plurality of planar-beam support structures are configured to provide a coupling means to adjacent said plurality of planar-beam support structures having said more than one multidirectional, conductive, coplanar-beams in registry therewith; wherein said coupling means is characterized by that: said more than one multidirectional, conductive, coplanar-beams in registry therewith, are configured to provide for the conjoint parabolic disposition of a plurality of non-rigid, shape-memory material elements.

### CROSS-REFERENCE TO RELATED APPLICATIONS

This application claims the priority under 35 USC 119(e) of U.S. Provisional Applications Nos. 61/686,378, entitled “Shape-memory Material Apparatus and Method”, filed on Apr. 4, 2012. This application is incorporated by reference into this application.

### BACKGROUND OF THE INVENTION

I. Technical Field

The present invention relates generally to biomimetic linear actuators and more particularly to a method and apparatus that utilizes a multifarious variety of displacive materials in order to provide an artificial muscle.

II. Background Discussion

The robotics industry has reached an interesting precipice, wherein the rigid, mechanical structure of robotics has become obsolete and antiquated. The industry has undergone an amazing revolution towards biomimicry, the literal imitation of nature and living biological systems. A critical element of biomimetics is basic locomotion and the physical movement of biological entities which is provided by organic muscle fiber. At present, a truly biomimetic actuator is necessary to satiate these needs and propel robotics into the realm of true biomimicry.

Conventional robotics often utilizes servo motors for gross movement, often complex gear configurations are necessary to convert the rotational movement of the motor into a linear action. As a consequence of the use of servo motors, the robots are bulky, overly complex and non-compliant; which translates into a delicate and easily damaged mechanism. Common stresses and moments experienced by biological systems can be catastrophic to traditional robotic mechanisms. However, other forms of actuation are available to modern roboticists in the form of hydraulic and pneumatic cylinders, which provide true linear actuation and a certain degree of natural compliance, unfortunately a major draw back to this method of actuation is the need for an external compressor/pump and engine to power such. Ergo, an actuator providing low weight/high strength, compact and compliant linear displacement and utilizing electrical/chemical input conversion into useable movement will be beneficial in the realization of biomimetic mechanisms and systems.

### SUMMARY OF THE INVENTION

Within the context of a biomimetic actuator a preferred embodiment is disclosed that provides a compact and compliant linear actuator. This is one of many preferred configurations of the actuator and is not intended to limit the scope of the present invention. In the following description, the use of “a”, “an”, or “the” can refer to the plural. All examples given are for clarification purposes only and are not intended to limit the scope of the present invention.

One preferred embodiment may provide support structures for a plurality of non-rigid, shape-memory material elements in registry therewith, such that the motive displacement of each shape-memory material element is utilized absolutely, without the need for extraneous or intermediate structures. Analogous to a myofibril, each non-rigid, shape-memory material element is suspended upon a support structure against gravity, providing a free-hanging, compliant linear actuator.

In one preferred aspect of the present invention the integrated linear actuator provides a uniform linear displacement-contraction. Within the context of embodiments of this preferred aspect, the actuator is configured to activate each non-rigid, shape-memory material element in a synchronous manner.

Within the context of another preferred aspect of the present invention the integrated linear actuator comprises a pliant, circumambient structure configured to provide a cohesive matrix, analogous to mammalian fascial tissue.

In another preferred aspect, the present invention provides a method for securing non-rigid, shape-memory material elements to any rigid body, in which a plurality of non-rigid, shape-memory material elements are fastened to supporting structures using industrial adhesive. This preferred method of securing non-rigid, shape-memory material elements provides an “organic” fastening means and eliminates the need for bolts, screws or pegs, thus reducing the weight and complexity of the integrated linear actuator.

### BRIEF DESCRIPTION OF THE DRAWINGS

FIG. 1A shows a perspective view of a preferred embodiment of an actuator in a divergent (relaxed) state.

FIG. 1B shows a perspective view of the actuator shown in FIG. 1A in a convergent (contracted) state.

FIG. 2 shows a perspective view of two linked planar-beam support structures connected to a possible energy source.

FIG. 3 shows a side view of a planar-beam support structure in registry with an orthogonal, periphery beam.

FIG. 4 shows a cut-away top view along section A-A of the planar-beam support structure shown in FIG. 3.

FIG. 5A shows a side view of a preferred embodiment of an integrated linear actuation system in a divergent (relaxed) state.

FIG. 5B shows the integrated linear actuation system shown in FIG. 5A in a convergent (contracted) state.

FIG. 6 shows a perspective view of the integrated linear actuation system fastened to jointed-rigid-members.

FIG. 7 shows a side view of a discrete array of planar-beam support structures in registry with a connector.

FIG. 8 shows a cut-away side view along section D-D of the connector, a coupling socket and one, first, adjacent planar-beam support structure.

FIG. 9 shows a side view of the integrated linear actuation system, a pliant, circumambient structure and at least two tubules.

FIG. 10A-10F shows a preferred method for securing a plurality of non-rigid, shape-memory material elements to more than one multidirectional, conductive, coplanar-beams.

### DETAILED DESCRIPTION OF THE INVENTION

In the following description, the use of “a”, “an”, or “the” can refer to the plural. All examples given are for clarification purposes only and are not intended to limit the scope of the present invention.

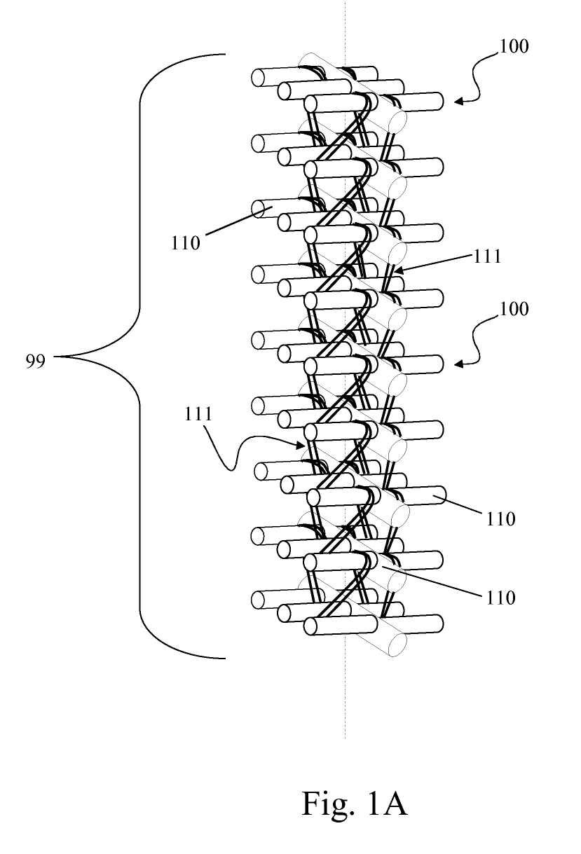

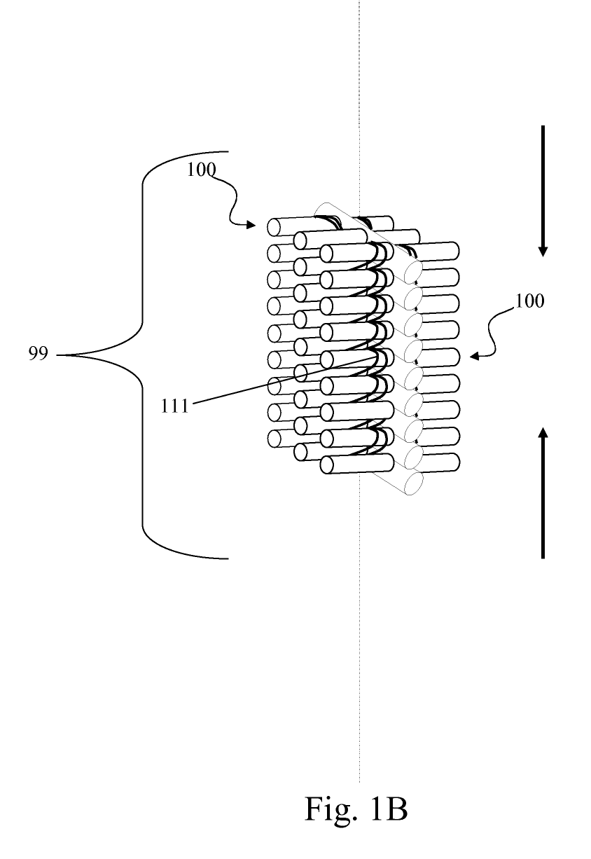

Referring to FIG. 1A, according to a preferred embodiment, an actuator 99 may comprise a plurality of linked planar-beam support structures 100 suspended and coupled via a plurality of shape-memory material elements 111. The plurality of planar-beam support structures 100, may be configured to converge and diverge, relative to each other, along a longitudinal axis and such the planar-beam support structures 100, may be configured to be disposed generally transverse to the aforementioned longitudinal axis.

The actuator 99 may be configured to cumulate the linear displacement and tractive (tension) force, of a plurality of pliant, non-rigid, shape-memory material elements 111, into a displacement-force of greater magnitude. As shown in FIG. 1B the actuator 99 may be configured to provide an absolute linear displacement or contraction analogous to mammalian skeletal muscle.

Within the context of one preferred embodiment of the present invention, a planar-beam support structure 100 may comprise more than one multidirectional, conductive, coplanar-beams 110, which may be configured to be substantially aligned to corresponding, multidirectional, conductive, coplanar-beams disposed in adjacent planar-beam support structures and such the planar-beam support structures 100 may be configured to conjointly incurvate a plurality of pliant, shape-memory material elements 111 upon an open-web of the aforementioned multidirectional, conductive, coplanar-beams 110.

multidirectional, conductive, coplanar-beams 110 may be configured to transmit tractive (tension) forces from preceding planar-beam support structures to succeeding planar-beam support structures via a plurality of incurvated, pliant, shape-memory material elements 111 and such the planar-beam support structures 100, may be configured to resist any kind of mechanical deformation (bending moments) resulting from external loads, imposed on the aforementioned open-web of multidirectional, conductive, coplanar-beams 110 and induced by the aforementioned plurality of incurvated, pliant, shape-memory material elements 111.

The multidirectional, conductive, coplanar-beams 110 may comprise any spatially orientated configuration (with reference to each other) such as transverse (orthogonal), parallel, oblique or any combination of aforementioned configurations, preferably a transverse spatial orientation with planar angles measuring between approximately, 80° and 100°, more preferably an orthogonal, spatial orientation, with planar angles measuring between approximately, 85° and 95°.

The multidirectional, conductive, coplanar-beams 110 may comprise any cross-sectional, closed plane curve shape such as circular, oval, elliptical or any smooth, parabolic shape, preferably a closed plane curve shape, more preferably an oval shape, with approximately two axes of symmetry.

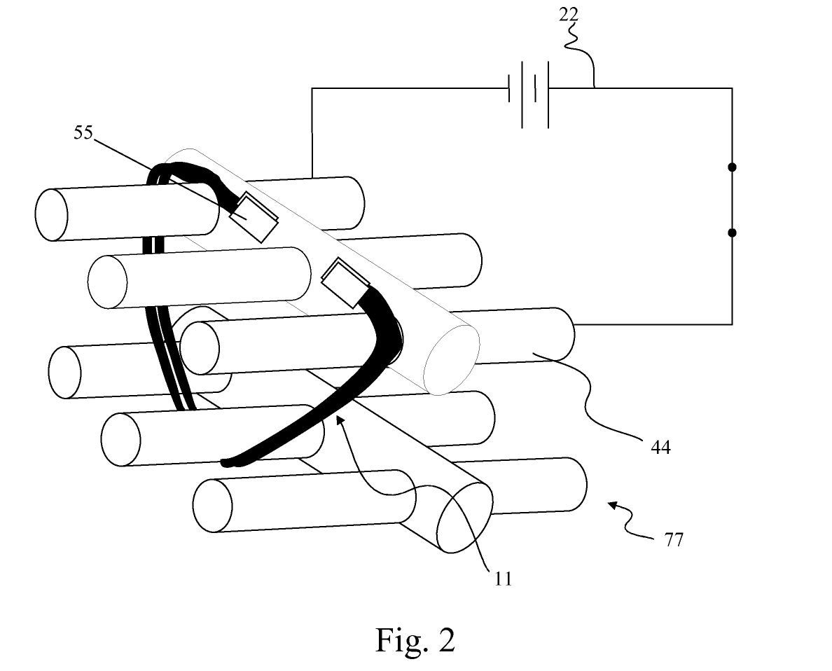

Referring to FIG. 2, the planar-beam support structures 77 may comprise a plurality of lamina partitions 55 which may be configured to provide a surface plane-contact surface for the attachment of the aforementioned plurality of incurvated, pliant, shape-memory material elements 11 (terminal ends) and such the lamina partitions 55 may be configured to maintain adherence to a multidirectional, conductive, coplanar-beams 44 via any resin, industrial adhesive or any substance that generates-maintains (attractive) Van der Waals forces between the aforementioned lamina partitions 55 and the aforementioned multidirectional, conductive, coplanar-beams 44.

The multidirectional, conductive, coplanar-beams 44 may be configured to conduct electrical-thermal energy (from an external or internal electrical power circuit 22) to a plurality of incurvated, pliant, shape-memory material elements 11, via a metallic-conductive coating or inherent conductive material and such the multidirectional, conductive, coplanar-beams 44 may be configured to be an electrical-thermal energy conduit, facilitating the controlled electrical-thermal activation, of the aforementioned plurality of incurvated, pliant, shape-memory material elements 11.

The multidirectional, conductive, coplanar-beams 44 may be configured to conduct electrical energy along the outer circumference of the beam (via a conductive coating) or through the entire cross-sectional area of the beam, via an inherently metallic-conductive material.

The multidirectional, conductive, coplanar-beams 44 may comprise any electrically conductive coating or material such as conductive carbon paint, conductive silver epoxy-paint/ink, conductive copper tape and any inherently conductive material such as carbon nanotubes, silver metal, copper metal, aluminum metal, gold metal and any conductive plastics [Poly(3,4-ethylenedioxythiophene)] or conductive rubber, preferably the multidirectional, conductive, coplanar-beams 44 may comprise a conductive coating over a light-weight, rigid substrate, more preferably the multidirectional, conductive, coplanar-beams 44 may comprise a conductive coating over a carbon tube enhanced polymer substrate.

The multidirectional, conductive, coplanar-beams 44 may comprise an impermeable coating which may be configured to provide a dielectric barrier to moisture, dust, chemicals or solvents and such the impermeable coating may be configured to be disposed on the surface of the aforementioned electrically conductive coating-material and any electrical contact surfaces.

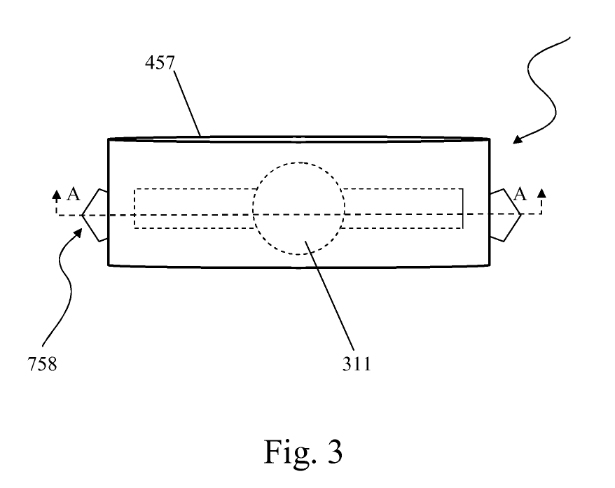

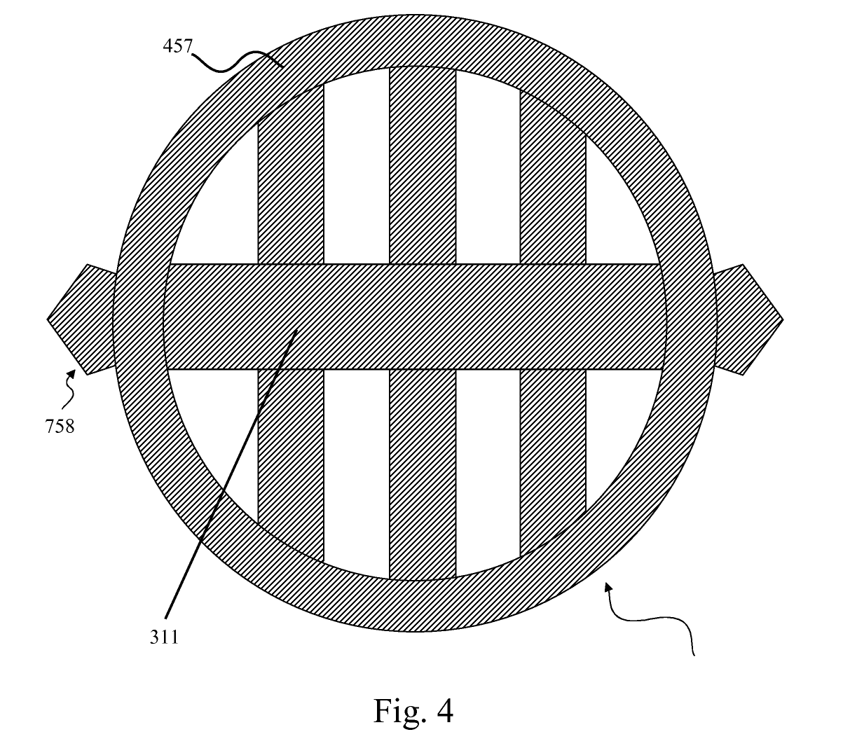

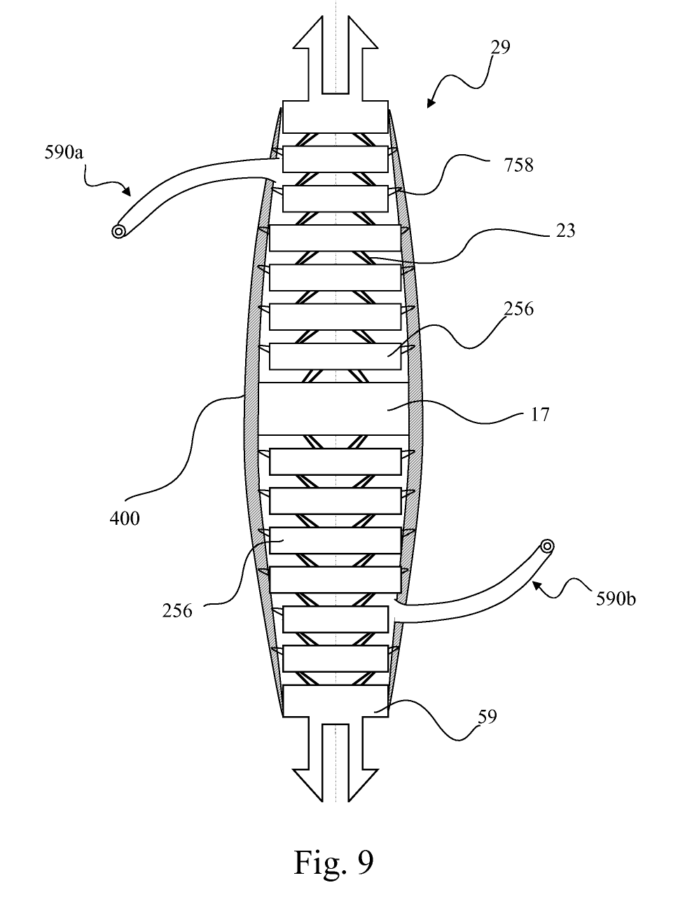

Referring to FIG. 3-4, 9 The planar-beam support structures 256 may comprise an orthogonal, periphery beam 457, which may be configured to transmit collateral (static) loads induced by a pliant, circumambient, structure 400 (FIG. 9) via a plurality of external convex splines 758 and such the orthogonal, periphery beam 457 may comprise any cross-sectional trapezoidal or rectilinear shape, which may be configured to be disposed substantially perpendicular to the terminal ends of the aforementioned multidirectional, conductive, coplanar-beams 44.

The external convex splines 758 may be configured to be disposed on the outermost contact surface of the aforementioned orthogonal, periphery beam 457 [opposite side of the multidirectional, conductive, coplanar-beams 44 terminal end junction] and such the external convex splines 758 may be configured to engage the interior contact surface of the aforementioned pliant, circumambient structure 400 (FIG. 9).

The external convex splines 758 may comprise any configuration-type of male splines such as Parallel key, involute, crowned, helical and serrated or any combination of the aforementioned configurations-types and such the external convex splines 758 may be configured to be disposed (in relation to the orthogonal, periphery beam 457) transversely, parallel or any combination of the aforementioned configurations.

The orthogonal, periphery beam 457 may comprise any spatial geometry such as linear, parabolic or any combination of the aforementioned geometries and such the orthogonal, periphery beam 457 may be configured to define the outer circumference of the aforementioned, planar-beam support structures 256, in any polygonal or closed plane curve shape, such as circular, oval, elliptical, rectangular, rhomboid and triangular.

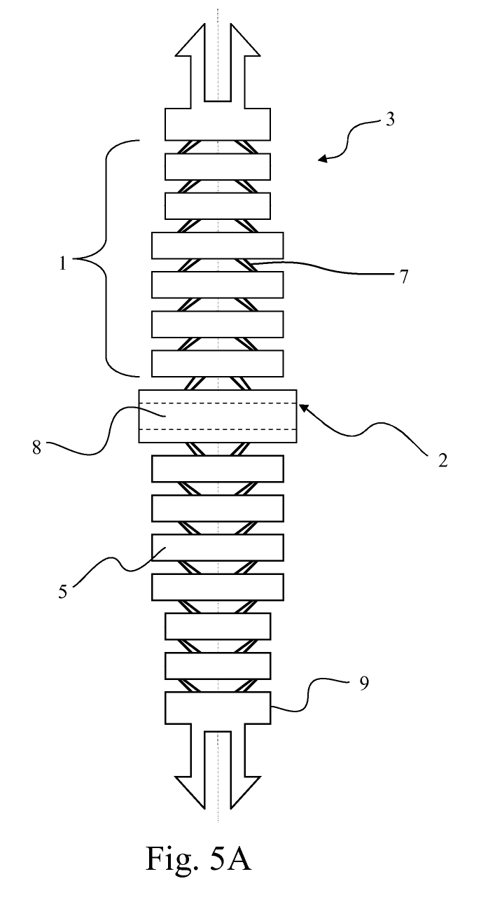

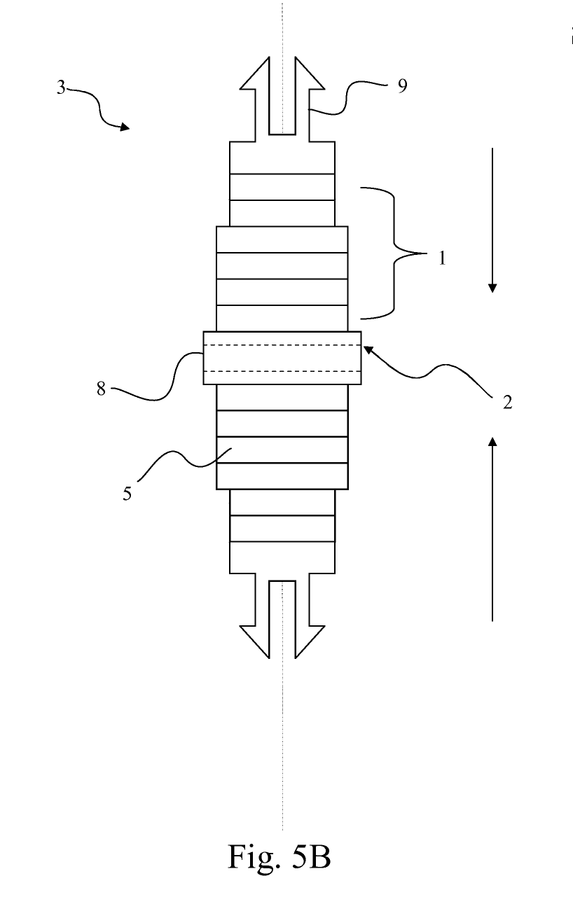

Referring to FIG. 5A-5B, The planar-beam support structures 5 may be configured to mechanically interconnect to each other (along a longitudinal axis) and to multiple, integral, components (via a plurality of pliant, non-rigid, shape-memory material elements 7) and such an integrated linear actuation system 3 may comprise at least one, central node 8 and a terminal connector 9.

The central node 8 may be configured to interconnect with, more than one, discrete arrays of planar-beam support structures 1 (via a plurality of pliant, non-rigid, shape-memory material elements 7) and such the central node 8 may be configured to provide a point of convergence for the aforementioned discrete arrays of planar-beam support structures 1.

The discrete array of equidistant, serial, planar-beam support structures 1 may comprise a plurality of planar-beam support structures 5, which may be configured to substantially decrease in relative size, proceeding, from a central node 8 to a terminal connector 9 and such the discrete array of planar-beam support structures 1 may be configured to generally taper in circumference, in relation to the central node 8.

The central node 8 may comprise at least two coupling sockets 2 which may be configured to be disposed along the outer periphery of, a substantially hollow, central housing and such the central node 8 may be configured to provide a mechanical-electrical interface between more than one, discrete arrays of planar-beam support structures 1 and multiple discrete-integrated components.

The central node 8 may comprise any three-dimensional shape such as spherical, spheroid, ovoid, discoid, torus, and any polyhedral shape, preferably a polyhedral shape, more preferably an octagonal prism shape.

The central node 8 may comprise any light-weight (low density) material with intrinsic mechanical properties such as high specific strength, high flexural modulus, high modulus of rigidity, high tensile strength and high heat deflection (thermal stability) and such the central node 8 may comprise any light-weight metal alloys, light-weight metal alloy foil laminates, metal matrix composites, high modulus polymers (plastics), fiber-reinforced polymers, carbon tube reinforced polymers and any materials containing allotropes of carbon.

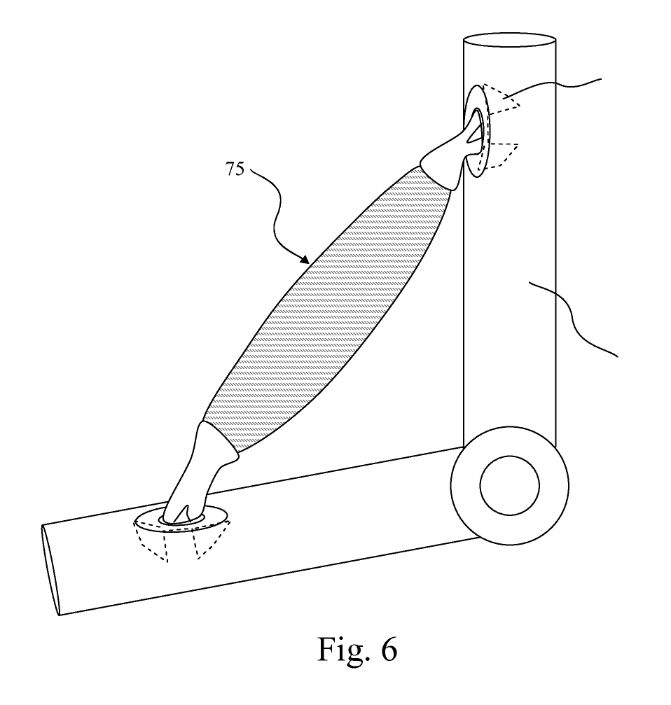

Referring to FIG. 6, The terminal connector 89, may be configured to mechanically fasten, the integrated linear actuation system 75, to any dynamic structure, rigid body segment, jointed-rigid-members (kinematics chain) 41, at any force transmission points, and such the terminal connectors 89 may be configured to transmit the tractive (tension) forces, generated by the integrated linear actuation system 75, to any of the aforementioned structures, while maintaining adherence during maximum tractive effort.

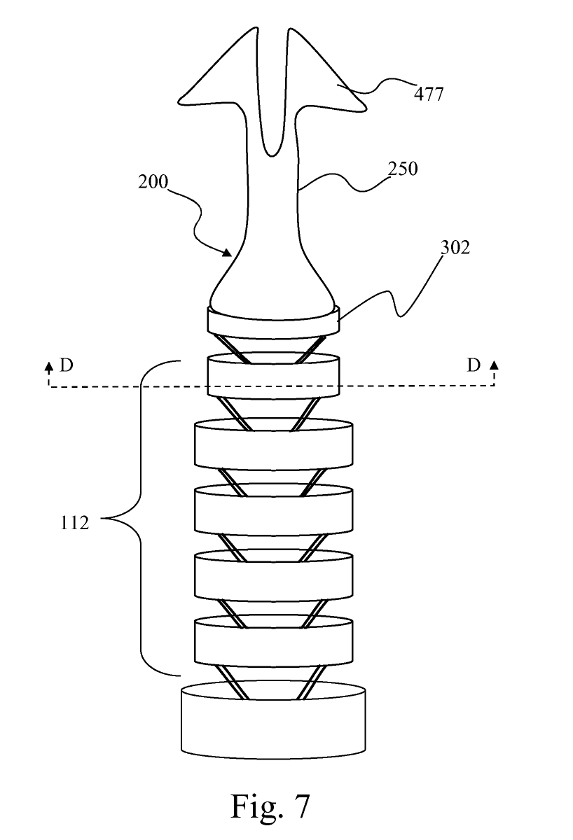

Referring to FIG. 7, the terminal connector 200 may comprise at least one coupling socket 302 which may be configured to be disposed substantially opposite of a generally elongate portion 250 and at least two, elongate projections 477 and such the terminal connector 200 may be configured to provide a mechanical interface between the terminal end of the discrete array of equidistant, serial, planar-beam support structures 112.

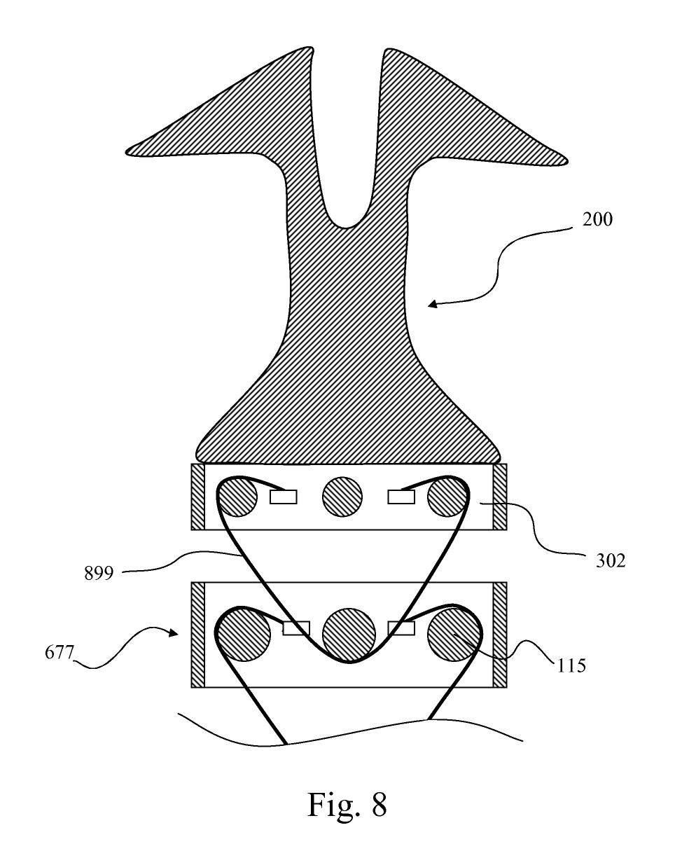

Referring to FIG. 8, the coupling socket 302 may be configured to engage the terminal end of a discrete array of equidistant, serial, planar-beam support structures 677, via more than one, multidirectional, conductive, coplanar-beams 115, which may be configured to receive a plurality of incurvated, pliant, shape-memory material elements 899.

The terminal connector 200 may comprise any light-weight (low density) material with intrinsic mechanical properties such as high tensile strength, high specific strength, high flexural modulus and high heat deflection (thermal stability) and such the terminal connector 200 may comprise any light-weight metal alloys and any high modulus polymers (plastics).

The integrated linear actuation system 29 may comprise at least one, pliant, circumambient structure 400, which may be configured to provide axial support and lateral stabilization to a plurality of planar-beam support structures 256 and multiple, mechanically linked, integral, components (at least one, central node 17 and a terminal connector 59 and such the pliant, circumambient structure 400 may be configured to encase the integrated linear actuation system 29 in a flexible-supportive matrix.

Referring to FIG. 9, the pliant, circumambient structure 400 may comprise a tubular sheath which may be configured to provide a three-dimensional, stabilizing-supportive, thermally insulated membrane to the aforementioned discrete array of planar-beam support structures 256 and such the pliant, circumambient structure 400 may be configured to embed-couple, multiple peripheral components such as a plurality of electrical wires, thermo-electrical-force-position sensors and more than one transport tubule 590.

The transport tubules 590 may comprise, at least one, inlet tubule 590a which may be configured to be coupled (at the distal end of the tubule) to a heat exchanged, fluid supply source; the transport tubules 590 (a, b) may further comprise, at least one, outlet tubule 590b which may be configured to transport a fluid medium, out of the fluid receptacle (the aforementioned pliant, circumambient structure 400) back to the heat exchanged fluid supply source and such the transport tubules 590 (a, b) may be configured to actively manage the thermal parameters of the aforementioned integrated linear actuation system 29 under varied operating conditions.

The pliant, circumambient structure 400 may comprise any viscoelastic material (synthetic or organic) with intrinsic mechanical properties such as a low Young's modulus, high yield strain and high heat deflection (thermal stability) and such the pliant, circumambient structure 400 may comprise any thermoplastic elastomers, polymer elastomers and any organic tissues-materials.

The pliant, circumambient structure 400 may comprise any thermoplastic or polymer elastomers such as: any styrenic block copolymers, polyolefin blends, elastomeric alloys (TPE-v or TPV), thermoplastic polyurethanes (elastomer), thermoplastic copolyester, natural-synthetic polyisoprene, polybutadiene rubber, chloroprene rubber, butyl rubber, styrene-butadiene rubber, nitrile rubber, silicon rubber (tin or platinum based), (porous) polytetrafluoroethylene, any elastomeric polymer gels and any polyurethane-polyurea copolymer elastomers.

The pliant, circumambient structure 400 may comprise any organic tissues-materials, with an extracellular matrix, such as epithelial tissue (stratified) and any fibrous connective tissues (dense regular/irregular).

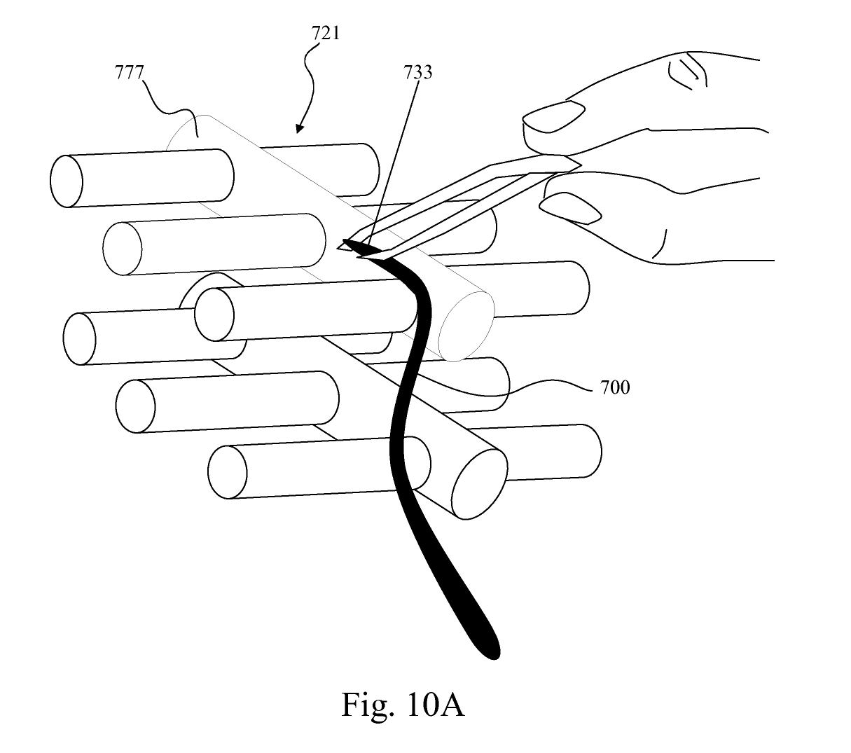

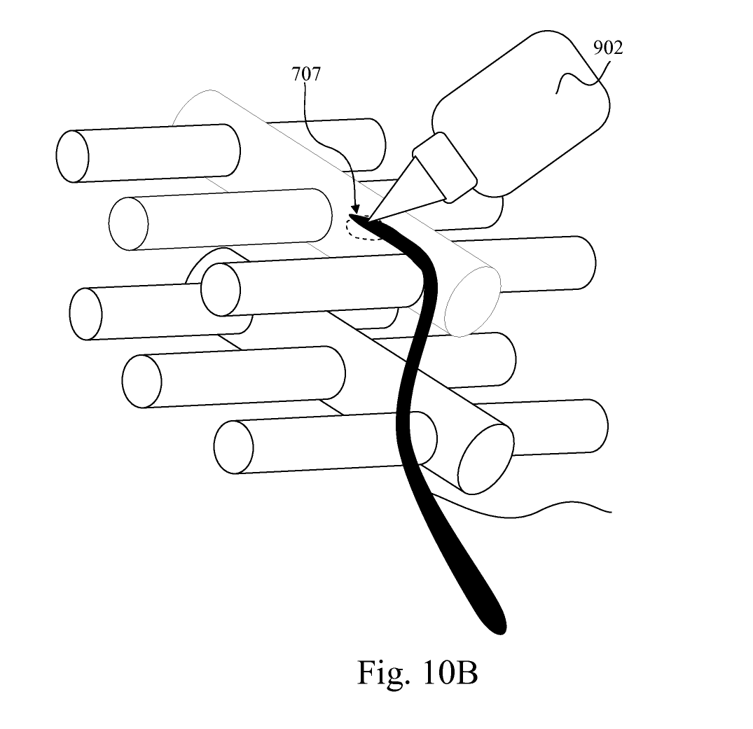

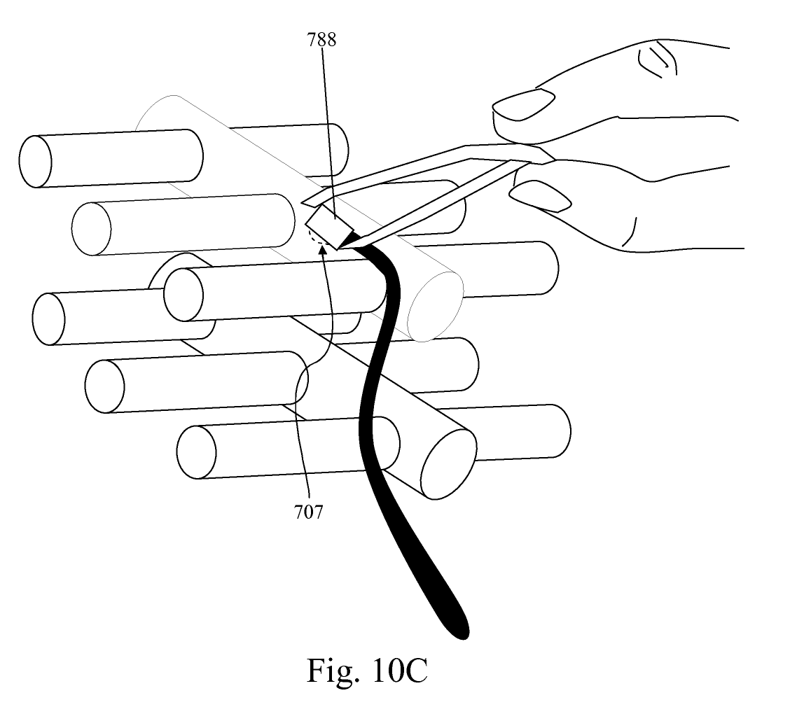

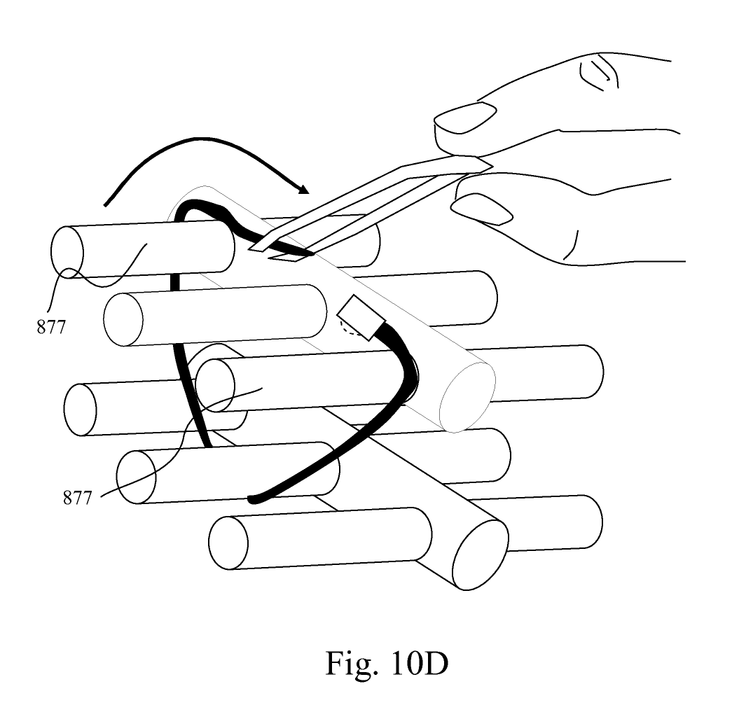

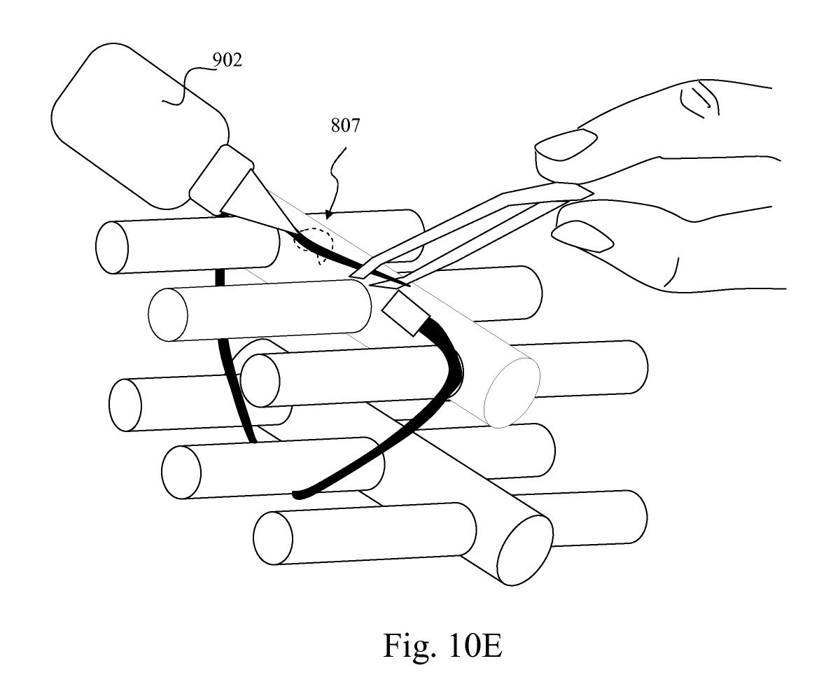

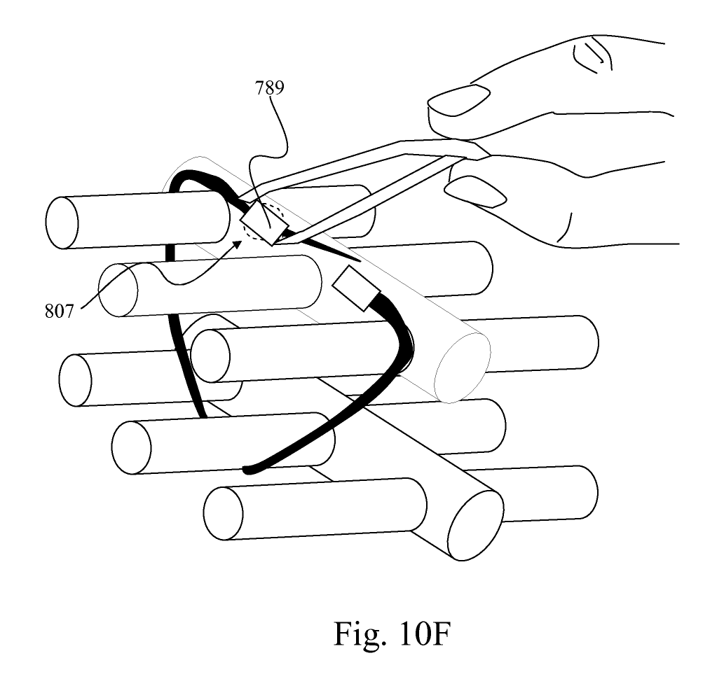

Within the context of one preferred embodiment of the present invention, FIG. 10 (A-F) illustrates a preferred method for securing a pliant, shape-memory material element 700 to a planar-beam support structure 721 comprising the first step of situating the first terminal end 733 of a non-rigid, shape-memory material element 700 in registry with the contact surface of a first multidirectional, conductive, coplanar-beam 777 (FIG. 10A).

Second step comprising the application of a bonding adhesive 902 to a first non-rigid, shape-memory material element-multidirectional, conductive, coplanar-beam contact junction 707 (FIG. 10B).

Third step comprising positioning of a first lamina partition 788 upon said non-rigid, shape-memory material element-multidirectional, conductive, coplanar-beam contact junction 707 to provide a glued joint (FIG. 10C).

Fourth step comprising incurvation of said non-rigid, shape-memory material element length having registry with, at least two, multidirectional, conductive, coplanar-beams 877 disposed in an adjacent planar-beam support structure (FIG. 10D).

Fifth step comprising application of bonding adhesive to a second non-rigid, shape-memory material element-multidirectional, conductive, coplanar-beam contact junction 807 (FIG. 10E).

Sixth step comprising positioning of a second lamina partition 789 upon said second non-rigid, shape-memory material element-multidirectional, conductive, coplanar-beam contact junction 807 to provide a second glued joint (FIG. 10F).

The integrated linear actuation system 29 (FIG. 9) may be configured to retain and utilize a multifarious variety of shape-memory material elements. Shape-memory material elements may comprise any material that exhibits an externally induced, displacive, shape memory (Austenite-Martensite) transition; via thermal, mechanical, magnetic, ultraviolet or electrical stimuli.

Shape-memory material elements may comprise any stimuli-responsive material with intrinsic, mechanical, shape memory effect properties such as thermal contraction-expansion (linear displacement), force generation-exertion, pseudo elasticity (super elasticity) and strain endurance. Shape-memory material elements may comprise any material with the aforementioned shape memory properties, such as shape-memory metal alloys and shape-memory polymers.

Shape-memory material elements may comprise any shape-memory metal alloys such as copper-zinc, copper-tin, copper-zinc-aluminum, copper-zinc-aluminum-nickel, copper-aluminum-nickel, copper-gold-zinc, manganese-copper, nickel-aluminum, and nickel-titanium, preferably an alloy of nickel-titanium, more preferably a nickel-titanium alloy with the trade name Flexinol®.

Shape-memory metal alloys may comprise any transition activation temperature (Austenite start temperature) such as −319° F. (−195° C.), −274° F. (−170° C.), −148° F. (−100° C.), −94° F. (−70° C.), −58° F. (−50° C.), 154.4° F. (68° C.), 156° F. (68.8° C.), 158° F. (70° C.), 190.4° F. (88° C.), 194° F. (90° C.), 199° F. (92.7° C.), 208.4° F. (98° C.), 212° F. (100° C.), preferably between approximately, 154.4° F. (68° C.) and 208.4° F. (98° C.), more preferably between approximately, 156° F. (68.8° C.) and 199° F. (92.7° C.).

Shape-memory material elements may comprise any shape-memory polymers such as polyethylene terephthalate (PET), polyethylene oxide (PEO), poly-(tetrahydrofuran), poly (1,4-butadiene) and poly (2-methyl-2-oxazoline) and any block copolymers containing polystyrene, preferably a styrene copolymer with a glass transition start temperature of approximately, between −20° F. (−30° C.) and 500° F. (260° C.), more preferably a styrene copolymer with the trade name Veriflex®.

Shape-memory material elements may comprise any cross-sectional, closed plane curve or polygonal shape such as circular, oval, elliptical, rectangular, rhomboid and triangular. Shape-memory material elements may comprise any form such as rods, bars, ribbons, helical springs and filaments (wires), preferably multi-diameter wires of nickel-titanium alloy, more preferably multi-diameter, nickel-titanium alloy wires with the trade name Flexinol®.

Shape-memory metal alloy wires may comprise any diameter such as 20 μm, 23 μm, 25 μm, 37 μm, 50 μm, 75 μm, 100 μm, 150 μm, 200 μm, 300 μm, 375 μm, 400 μm, 508 μm, 510 μm and 630 μm.

The planar-beam support structures 256 may comprise any light-weight (low density) material with intrinsic mechanical properties such as high specific strength, high flexural modulus, high modulus of rigidity and high heat deflection (thermal stability) and such the planar-beam support structures 256 may comprise any light-weight metal alloys, light-weight metal alloy foil laminates, metal matrix composites, high modulus polymers (plastics), fiber-reinforced polymers, carbon tube reinforced polymers, any materials containing allotropes of carbon, any smart materials (self-healing polymers, shape-memory polymers, piezoelectric materials), any auxetic materials (materials with a negative Poisson's ratio) and any rigid, organic-botanical, tissues-materials.

The planar-beam support structures 256 may comprise any light-weight metal alloys such as titanium metal alloy, aluminum metal alloy, magnesium metal alloy and any light-weight alloys containing beryllium and such the planar-beam support structures 256 may comprise any metal alloy foil laminates, which may incorporate thin foils of the aforementioned metal alloys.

The planar-beam support structures 256 may comprise any metal matrix composites such as: aluminum metal alloy matrix with carbon fiber particulate, aluminum metal alloy matrix with silicon carbide particulate, aluminum metal alloy matrix with boron carbide particulate, titanium metal alloy matrix with carbon fiber particulate, titanium metal alloy matrix with silicon carbide particulate, titanium metal alloy matrix with boron carbide particulate, magnesium metal alloy matrix with carbon fiber particulate, magnesium metal alloy matrix with silicon carbide particulate and magnesium metal alloy matrix with boron carbide particulate.

The planar-beam support structures 256 may comprise any light-weight, high modulus polymers (plastics) including all thermosetting and thermosoftening polymers such as acrylonitrile butadiene styrene (ABS), Polyether ether ketone (PEEK), polyamide, polyimide, polyamide-imide, polycarbonate, polyoxymethylene, polypropylene, expanded polypropylene, polyethylene, ultra-high-molecular-weight polyethylene and polymethylacrylate.

The planar-beam support structures 256 may comprise any fiber reinforced laminates (in an epoxy or polyester resin matrix) such as glass fiber, carbon fiber (pyrolytic carbon), para-aramid fiber and ultra-high-molecular-weight polyethylene fiber or any combination of the aforementioned fiber-matrix systems.

The planar-beam support structures 256 may comprise any material containing allotropic forms of carbon such as carbon tube (nano-colossal) and diamond fiber enhanced epoxy resins, pyrocarbon material and graphene oxide paper.

The planar-beam support structures 256 may comprise any smart materials such as polyvinylidene fluoride (piezoelectric polymer), barium titanate, lead zirconate titanate, sodium tungstate (piezoelectric ceramics), metallo-supramolecular polymers (self-healing polymer), dynamic syntactic foams (shape-memory material) and any shape-memory polymers.

The planar-beam support structures 256 may comprise any auxetic materials (materials with a negative Poisson's ratio) such as microporous polymers, molecular-level auxetic polymers, polymeric-metallic foams and sintered ceramics.

The planar-beam support structures 256 may comprise any organic-botanical, tissues-materials such as osseous (compact and spongy) tissue, xylem tissue and any combination of the aforementioned tissues-materials.

Within the context of one preferred embodiment of the present invention, FIG. 9 shows a side view of an integrated linear actuation system 29 in operation. This is one of many preferred configurations of the integrated linear actuation system 29 and is not intended to limit the scope of the present invention. In the following description, the use of “a,” “an,” or “the” can refer to the plural. All examples given are for clarification purposes only and are not intended to limit the scope of the present invention.

The integrated linear actuation system 29 may be configured to provide a biomimetic actuator, which may be configured to be equivalent to a mammalian skeletal muscle in (relative) size, shape and function and such the integrated linear actuation system 29 may be configured to contract and exert force on any external object or objects, in opposition to earth's gravity.

Analogous to a myofibril, each pliant, non-rigid, shape-memory material element 23 may be configured to contract in the same manner as a biological muscle fiber and such the integrated linear actuation system 29 may be configured to (synchronously) cumulate the minute displacement of each individual pliant, shape-memory material element 23 into a higher magnitude displacement, providing a uniform linear displacement-contraction.

The integrated linear actuation system 29 may comprise a pliant, circumambient structure 400 which may be configured to provide a biomechanical connective structure, analogous to mammalian fascial tissue and such the pliant, circumambient structure 400 may be configured to surround and suspend each planar-beam support structure 256 in order to provide a compliant, united-cohesive structure.

Analogous to mammalian fascial tissue the pliant, circumambient structure 400 may be configured to insulate the aforementioned integrated linear actuation system 29, thermally and mechanically in order to provide a robust, compliant linear actuator.

Within the context of preferred or practical applications of the present invention, the following description elucidates some of many realistic and practical applications of integrated linear actuation system and is not intended to limit the scope of the present invention. Within the realm of modern robotics and biomimicry, the integrated linear actuation system may be configured to provide efficient, compliant, linear actuation; while exerting a high magnitude of tension force. Some of the possible applications include (but are not limited to): General robotics, biomechanical prosthetic limbs, exoskeleton prostheses (muscle amplification) and biomimetic androids.

I claim:

1. An actuator providing linear displacement, comprising: a plurality of planar-beam support structures disposed along a longitudinal axis; wherein each said plurality of planar-beam support structures are configured with more than one multidirectional, conductive, coplanar-beams disposed therein; such that said plurality of planar-beam support structures are configured to provide a coupling means to adjacent said plurality of planar-beam support structures having said more than one multidirectional, conductive, coplanar-beams in registry therewith; wherein said coupling means is characterized by that: said more than one multidirectional, conductive, coplanar-beams in registry therewith, are configured to provide for the conjoint parabolic disposition of a plurality of non-rigid, shape-memory material elements.

2. The actuator as claimed in claim 1, wherein said plurality of planar-beam support structures are configured for convergent-divergent displacement, relative to adjacent said plurality of planar-beam support structures.

3. The actuator as claimed in claim 1, wherein said plurality of non-rigid, shape-memory material elements comprises any material that provides a displacive phase transformation, via internally-externally induced thermal, mechanical, magnetic, ultraviolet or electrical stimuli.

4. The actuator as claimed in claim 1, wherein said plurality of planar-beam support structures are configured to comprise any material that provides a high specific strength, high flexural modulus, high modulus of rigidity and thermal stability; such that said plurality of planar-beam support structures are configured to comprise any of the following materials: a. any light-weight metal alloys; b. any light-weight metal alloy foil laminates; c. any metal matrix composites; d. any high modulus polymers; e. any fiber-reinforced polymers or resins; f. any carbon tube or graphene reinforced polymers; g. any shape-memory alloys or polymers; h. any piezoelectric materials; I. any auxetic materials; J. any organic-botanical, tissues or materials.

5. The actuator as claimed in claim 1, wherein said more than one multidirectional, conductive, coplanar-beams in registry with said plurality of non-rigid, shape-memory material elements are configured to provide a conduit for the transmission of electrical-thermal energy therebetween.

6. The actuator as claimed in claim 1, wherein said more than one multidirectional, conductive, coplanar-beams are configured to further comprise any of the following materials: a. any electrically-thermally conductive material or coating; b. any paint or coating containing carbon; c. any paint or ink containing silver; d. any material or coating made of carbon nanotubes or graphene; e. any conductive metals; f. any conductive polymers or resins; g. any conductive organic-botanical, tissues or materials.

7. The actuator as claimed in claim 1, further comprising: at least one orthogonal, periphery beam; wherein said at least one orthogonal, periphery beam is configured to provide an outer portion in registry with the terminal ends of said more than one multidirectional, conductive, coplanar-beams.

8. The actuator as claimed in claim 1, further comprising: a plurality of external convex splines; wherein said plurality of external convex splines are in registry with the outer circumference of said at least one orthogonal, periphery beam.

9. An integrated linear actuation system, comprising: a central node; and more than one discrete arrays of planar-beam support structures in registry therewith; wherein said central node is configured to provide a point of convergence for said more than one discrete arrays of planar-beam support structures; a connector in registry with the terminal end of each said more than one discrete arrays of planar-beam support structures, wherein said connector is configured for disposition substantially opposed to said central node; wherein said integrated linear actuation system is characterized by that: said more than one discrete arrays of planar-beam support structures, central node, connector and a plurality of non-rigid, shape-memory material elements are configured having registry therewith.

10. The integrated linear actuation system as claimed in claim 8, wherein said central node further comprises at least two coupling sockets configured to provide a coupling means for each said more than one discrete arrays of planar-beam support structures.

11. The integrated linear actuation system as claimed in claim 8, wherein said connector is configured to provide a fastening means for each said more than one discrete arrays of planar-beam support structures, such that said connector is configured to transmit tension forces from said integrated linear actuation system to any rigid body segments or jointed-rigid-members.

12. The integrated linear actuation system as claimed in claim 8, wherein said connector further comprises a coupling socket disposed substantially opposed to a generally elongate portion and at least two elongate projections disposed therein; wherein said connector is characterized by that: said coupling socket is configured to provide an interface with any adjacent said planar-beam support structure.

13. The integrated linear actuation system as claimed in claim 8, further comprising a pliant, circumambient structure configured to provide a flexible sheathing membrane to said integrated linear actuation system; wherein said pliant, circumambient structure is configured to provide the following: a. three-dimensional stability; b. thermal insulation; c. retention of multiple peripheral components; d. retention of any fluid medium.

14. The integrated linear actuation system as claimed in claim 8, wherein said pliant, circumambient structure further comprises at least two tubules configured to provide for the transport of a thermally dynamic fluid; wherein thermal energy is dissipated and recovered via a thermal exchanger.

15. The integrated linear actuation system as claimed in claim 8, wherein said pliant, circumambient structure is configured to comprise any of the following materials: a. any thermoplastic elastomers; b. any polymer elastomers; c. any elastomeric polymer gels; d. any elastic organic tissues-materials.

16. In a planar-beam support structure having more than one multidirectional, conductive, coplanar-beams in registry with a plurality of non-rigid, shape-memory material elements, the method for securing said plurality of non-rigid, shape-memory material elements to said more than one multidirectional, conductive, coplanar-beams comprising: a. Situating the first terminal end of a non-rigid, shape-memory material element in registry with the contact surface of a first multidirectional, conductive, coplanar-beam; b. application of bonding adhesive to a first non-rigid, shape-memory material element-multidirectional, conductive, coplanar-beam contact junction; c. positioning of a first lamina partition upon said non-rigid, shape-memory material element-multidirectional, conductive, coplanar-beam contact junction to provide a glued joint. d. Incurvation of said non-rigid, shape-memory material element length having registry with, at least two, multidirectional, conductive, coplanar-beams disposed in an adjacent planar-beam support structure; e. application of bonding adhesive to a second non-rigid, shape-memory material element-multidirectional, conductive, coplanar-beam contact junction; f. positioning of a second lamina partition upon said second non-rigid, shape-memory material element-multidirectional, conductive, coplanar-beam contact junction to provide a second glued joint.

17. The method of claim 14, wherein said lamina partitions are a plurality.

18. The method of claim 14, wherein said lamina partitions are configured for modularity.
